(19) United States
(12) Patent Application Publication
(10) Pub. No.: US 2024/0167910 A1
(43) Pub. Date: May 23, 2024

(54) TELESCOPIC STICK FOR ONLINE ULTRASONIC TESTING

(71) Applicant: SAUDI ARABIAN OIL COMPANY, Dhahran (SA)

(72) Inventors: Hatem M. Elashmawi, Udhailiyah (SA); Yazeed S. Alsalamah, Al Mubarraz (SA); Shadi M. Al-Hazmi, Al-Ahsa (SA)

(73) Assignee: SAUDI ARABIAN OIL COMPANY, Dhahran (SA)

(21) Appl. No.: 18/056,893

(22) Filed: Nov. 18, 2022

(51) Int. Cl. G01M 7/02

(52) U.S. Cl. CPC G01M 7/025; G01M 7/027

(57) ABSTRACT

A telescopic stick for on-stream inspection of an equipment structure is disclosed. The telescopic stick includes telescopic segments, two swivel segments with two swivel joints, a mounting head attached to the swivel segments, an ultrasonic transducer (UT) probe mounted on the mounting head via a spring, and an electromagnetic leg protruding from the mounting head and adjacent to the UT probe, where an extended length of the telescopic segments exceeds human reach to allow a user accessing an out-of-reach condition monitoring location (CML) on the equipment structure, where the electromagnetic leg, when energized, engages the UT probe against the spring onto a ferro-magnetic surface of the equipment structure at the out-of-reach CML, where the engaged UT probe generates an UT measurement representing a condition of the equipment structure at the out-of-reach CML.

### BACKGROUND

Oil and gas facilities require frequent inspection in order to ensure integrity of equipment structures and safe work practices. On-stream inspection (OSI) is performed on equipment and piping, such as a pressure vessel, while it is on-stream (i.e., in service or online) to establish the suitability of the pressure boundary for continued operation. However, accessing equipment structures in the oil and gas facilities is becoming more difficult due to their various heights and sizes. The major challenge in ongoing OSI program is the inspection of out-of-reach condition monitoring locations (CMLs) of the equipment structures. Where the conditions to be monitored pertain to metal corrosion condition, the term CML also refers to corrosion monitoring location.

The conventional way to inspect the out-of-reach CMLs is to erect scaffold in order to give the inspector an access to these out-of-reach locations for performing thickness measurement using ultrasonic transducer (UT) probe connected to UT device. Inspecting out-of-reach CMLs by erecting the scaffold incurs high cost and long-time delay to conduct the required inspection.

### SUMMARY

In general, in one aspect, the invention relates to a telescopic stick for on-stream inspection (OSI) of an equipment structure in an oil and gas facility. The telescopic stick includes a plurality of telescopic segments, a first swivel segment and a second swivel segment, a first swivel joint coupling the plurality of telescopic segments to the first swivel segment, a second swivel joint coupling the first swivel segment to the second swivel segment, a mounting head attached to the second swivel segment opposite the second swivel joint, an ultrasonic transducer (UT) probe mounted on the mounting head via a spring, and an electromagnetic leg protruding from the mounting head and adjacent to the UT probe, wherein an extended length of the plurality of telescopic segments exceeds a pre-determined length of human reach to allow a user accessing an out-of-reach condition monitoring location (CML) on the equipment structure, wherein the electromagnetic leg, when energized, engages the UT probe against the spring onto a ferro-magnetic surface of the equipment structure at the out-of-reach CML, wherein the engaged UT probe generates an UT measurement representing a condition of the equipment structure at the out-of-reach CML, wherein an alarm is generated in response to the UT measurement differs from a baseline UT measurement of the out-of-reach CML by a pre-determined threshold, and wherein a maintenance operation of the equipment structure is performed in response to the alarm.

In general, in one aspect, the invention relates to a system for on-stream inspection of an equipment structure in an oil and gas facility. The system includes a telescopic stick comprising a plurality of telescopic segments, a first swivel segment and a second swivel segment, a first swivel joint coupling the plurality of telescopic segments to the first swivel segment, a second swivel joint coupling the first swivel segment to the second swivel segment, a mounting head attached to the second swivel segment opposite the second swivel joint, an ultrasonic transducer (UT) probe mounted on the mounting head via a spring, and an electromagnetic leg protruding from the mounting head and adjacent to the UT probe, wherein an extended length of the plurality of telescopic segments exceeds a pre-determined length of human reach to allow a user accessing an out-of-reach condition monitoring location (CML) on the equipment structure, wherein the electromagnetic leg, when energized, engages the UT probe against the spring onto a ferro-magnetic surface of the equipment structure at the out-of-reach CML, wherein the engaged UT probe generates an UT measurement representing a condition of the equipment structure at the out-of-reach CML, and a data-gathering and analysis system configured to obtain the UT measurement from the UT probe, store the UT measurement in a collection of UT measurements of a periodic OSI program, generate, in response to the UT measurement differs from a baseline UT measurement of the out-of-reach CML by a pre-determined threshold, an alarm, and facilitate, in response to the alarm, a maintenance operation of the equipment structure in the oil and gas facility.

In general, in one aspect, the invention relates to a method on-stream inspection (OSI) of an equipment structure in an oil and gas facility. The method includes obtaining a telescopic stick comprising a plurality of telescopic segments, a first swivel segment and a second swivel segment, a first swivel joint coupling the plurality of telescopic segments to the first swivel segment, a second swivel joint coupling the first swivel segment to the second swivel segment, a mounting head attached to the second swivel segment opposite the second swivel joint, an ultrasonic transducer (UT) probe mounted on the mounting head via a spring, and an electromagnetic leg protruding from the mounting head and adjacent to the UT probe, extending the plurality of telescopic segments to exceed a pre-determined length of human reach to allow a user accessing an out-of-reach condition monitoring location (CML) on the equipment structure, energizing the electromagnetic leg to engage the UT probe against the spring onto a ferro-magnetic surface of the equipment structure at the out-of-reach CML, generating, by the engaged UT probe, an UT measurement representing a condition of the equipment structure at the out-of-reach CML, generating, in response to the UT measurement differs from a baseline UT measurement of the out-of-reach CML by a pre-determined threshold, an alarm, and facilitating, in response to the alarm, a maintenance operation of the equipment structure in the oil and gas facility.

Other aspects and advantages will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A-1C show a system in accordance with one or more embodiments.

FIG. 2 shows a flowchart in accordance with one or more embodiments.

FIGS. 3A-3B show an example in accordance with one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments of the invention provide a method and a tool (referred to as a telescopic stick, or a stick) for online ultrasonic testing that enables a user to easily reach elevated locations for inspection activities. In one or more embodiments, the stick is used to perform OSI of equipment and piping network at oil and gas facilities. The stick is equipped with an electromagnetic leg, a flexible probe and swivel joints for ease of mounting the UT probe and reaching out-of-reach inspection locations. Utilizing this tool increases workplace safety, reduces the amount of labor required, and eliminates the use of scaffolding resulting in cost savings.

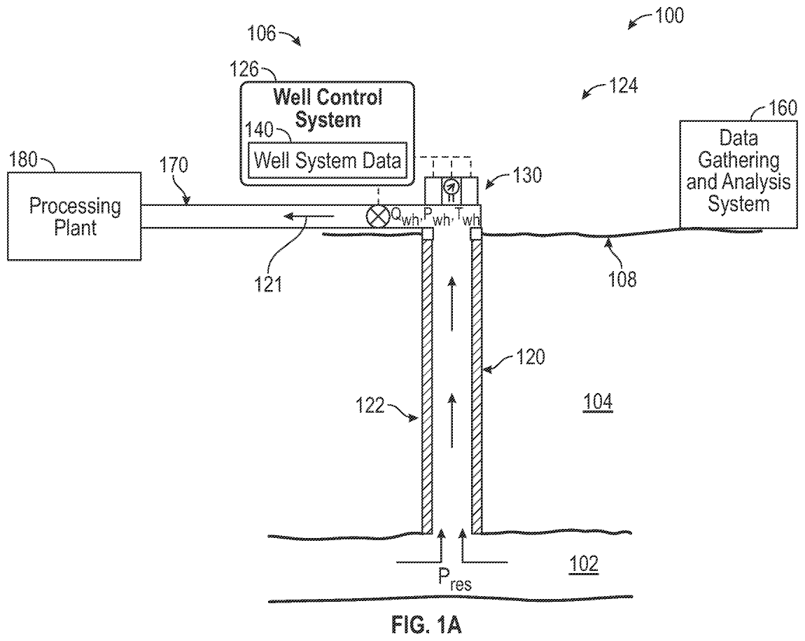

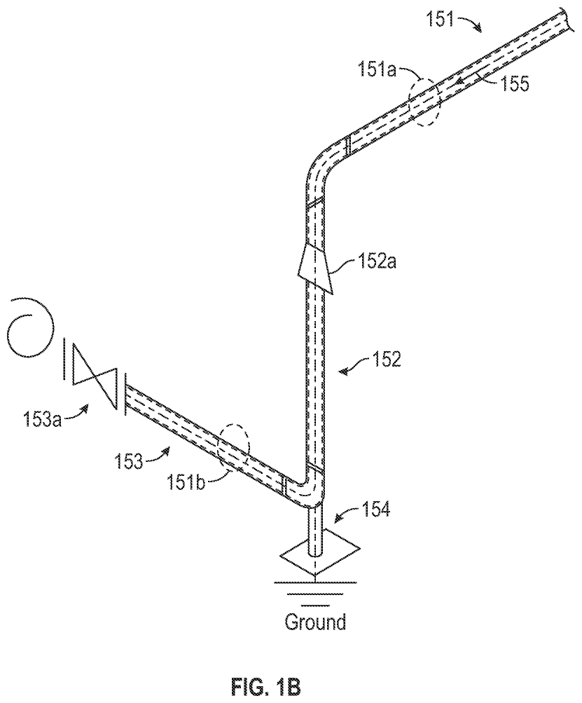

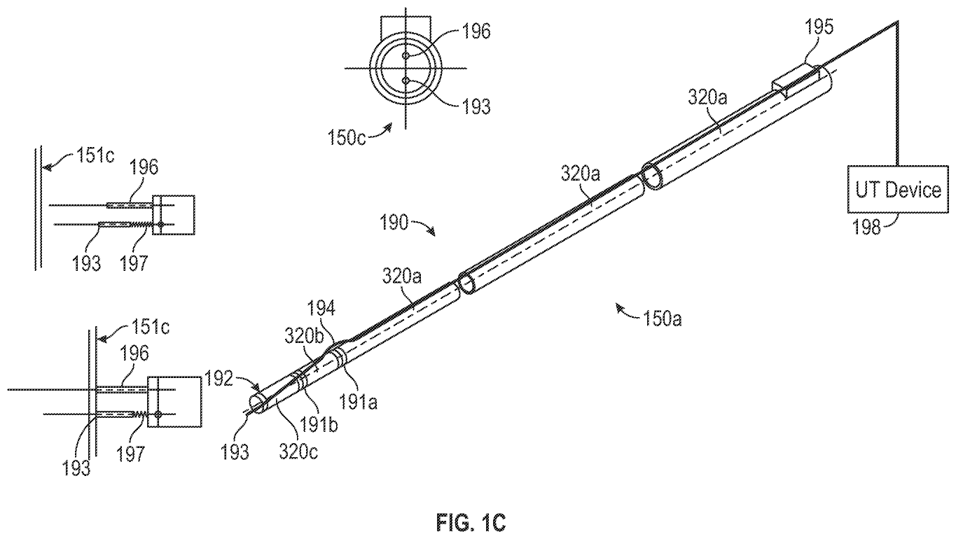

Turning to FIG. 1A, FIG. 1A shows a schematic diagram of an oil and gas facility in accordance with one or more embodiments. As shown in FIG. 1A, FIG. 1A illustrates a well environment (100) that includes a hydrocarbon reservoir (“reservoir”) (102) located in a subsurface hydrocarbon-bearing formation (“formation”) (104) and a well system (106). The hydrocarbon-bearing formation (104) may include a porous or fractured rock formation that resides underground, beneath the earth's surface (“surface”) (108). In the case of the well system (106) being a hydrocarbon well, the reservoir (102) may include a portion of the hydrocarbon-bearing formation (104). The hydrocarbon-bearing formation (104) and the reservoir (102) may include different layers of rock having varying characteristics, such as varying degrees of permeability, porosity, capillary pressure, and resistivity. In the case of the well system (106) being operated as a production well, the well system (106) may facilitate the extraction of hydrocarbons (or “production”) from the reservoir (102). The well system (106) may be part of a production system that further includes a pipeline network (170) and a processing plant (180) for transporting and processing the hydrocarbons, i.e., production from the reservoir (102).

In some embodiments, the well system (106) includes a wellbore (120), a well sub-surface system (122), a well surface system (124), and a well control system (“control system”) (126). The control system (126) may control various operations of the well system (106), such as well production operations, well completion operations, well maintenance operations, and reservoir monitoring, assessment and development operations. In some embodiments, the control system (126) includes a computer system.

The wellbore (120) may include a bored hole that extends from the surface (108) into a target zone of the hydrocarbon-bearing formation (104), such as the reservoir (102). An upper end of the wellbore (120), terminating at or near the surface (108), may be referred to as the “up-hole” end of the wellbore (120), and a lower end of the wellbore, terminating in the hydrocarbon-bearing formation (104), may be referred to as the “down-hole” end of the wellbore (120). The wellbore (120) may facilitate the circulation of drilling fluids during drilling operations, the flow of hydrocarbon production (“production”) (121) (e.g., oil and gas) from the reservoir (102) to the surface (108) during production operations, the injection of substances (e.g., water) into the hydrocarbon-bearing formation (104) or the reservoir (102) during injection operations, or the communication of monitoring devices (e.g., logging tools) into the hydrocarbon-bearing formation (104) or the reservoir (102) during monitoring operations (e.g., during in situ logging operations).

In some embodiments, during operation of the well system (106), the control system (126) collects and records well system data (140) for the well system (106). The well system data (140) may include, for example, a record of measurements of wellhead pressure (P_{wh}) (e.g., including flowing wellhead pressure), wellhead temperature (T_{wh}) (e.g., including flowing wellhead temperature), wellhead production rate (Q_{wh}) over some or all of the life of the well (106), and water cut data. The well system data (140) may further include monitoring data of equipment structures at the wellsite such as OSI monitoring data. Throughout this disclosure, the term “equipment structure” refers to mechanical structures of equipment and piping network. In some embodiments, the measurements and monitoring data are recorded in real-time, and are available for review or use within seconds, minutes or hours of the condition being sensed (e.g., the measurements are available within 1 hour of the condition being sensed). In such an embodiment, the well system data (140) may be referred to as “real-time” well system data (140). Real-time well system data (140) may enable an operator of the well (106) to assess a relatively current state of the well system (106) and make real-time decisions regarding development and maintenance of the well system (106) and the reservoir (102), such as on-demand adjustments in regulation of production flow from the well or preventive maintenance of equipment structures to prevent disruption to the production flow from the well.

In some embodiments, the well sub-surface system (122) includes casing installed in the wellbore (120). For example, the wellbore (120) may have a cased portion and an uncased (or “open-hole”) portion. The cased portion may include a portion of the wellbore having casing (e.g., casing pipe and casing cement) disposed therein.

In some embodiments, the well surface system (124) includes a wellhead (130). The wellhead (130) may include a rigid structure installed at the “up-hole” end of the wellbore (120), at or near where the wellbore (120) terminates at the Earth's surface (108). The wellhead (130) may include structures for supporting (or “hanging”) casing and production tubing extending into the wellbore (120). Production (121) may flow through the wellhead (130), after exiting the wellbore (120) and the well sub-surface system (122), including, for example, the casing and the production tubing.

In some embodiments, the well system (106) includes a data-gathering and analysis system (160). For example, the data-gathering and analysis system (160) may include hardware and/or software with functionality for facilitating operations of the well system (106), such as well production operations, well drilling operation, well completion operations, well maintenance operations, and reservoir monitoring, assessment and development operations. For example, the data-gathering and analysis system (160) may store well system data (140) such as OSI monitoring data. In some embodiments, the data-gathering and analysis system (160) may analyze the OSI monitoring data to generate recommendations to facilitate various operations of the well system (106), such as a preventive maintenance of the equipment structures. While the data-gathering and analysis system (160) is shown at a wellsite, embodiments are contemplated the data-gathering and analysis system (160) is located away from well sites.

While the OSI monitoring data is described above for equipment structures installed in the well system (106), additional and/or alternative monitoring data may correspond to equipment structures installed in the pipeline network (170) and/or the processing plant (180). In one or more embodiments, the processing plant (180) is an industrial process plant such as an oil/petroleum refinery where petroleum (crude oil) is transformed and refined, or other types of chemical processing plants. The processing plant (180) typically includes large, sprawling industrial complexes with extensive piping network running throughout, carrying streams or liquids between large chemical processing units, such as distillation columns. Processing plant facilities require frequent inspection in order to ensure the asset integrity of the structure and safe work practices. Accessing the processing plant structures and equipment can be difficult due to their various heights and sizes. Thus, embodiments disclosed herein are directed to testing equipment structures and pipeline networks associated with processing plants which can easily reach elevated locations for inspection activities.

While the oil and gas facilities are shown as including the well environment (100) and processing plant (180), in one or more embodiments, the oil and gas facilities may additionally or alternatively include equipment (pressure vessels), storage tanks, piping and an associated pipeline network.

Turning to FIG. 1B, FIG. 1B shows a schematic diagram in accordance with one or more embodiments. In one or more embodiments, one or more of the modules and/or elements shown in FIG. 1B may be omitted, repeated, and/or substituted. Accordingly, embodiments of the invention should not be considered limited to the specific arrangements of modules and/or elements shown in FIG. 1B.

As shown in FIG. 1B, FIG. 1B illustrates a portion of equipment structures installed in the well environment (100) and/or processing plant (180) depicted in FIG. 1A above. In particular, the equipment structure shown in FIG. 1B includes bent sections of a pipeline having an upper horizontal section (151) and lower horizontal section (153) that are connected via the vertical section (152). The pipeline is supported on the ground by way of a mechanical support structure (154). The lower horizontal section (153) incudes a valve (153a) and the vertical section (152) includes a reducer (152a). Fluids flow through the pipeline during the on-stream condition as indicated by the arrow (155). For illustration purposes, the vertical section (152) has a length of maximum 10 meters from the ground level, rendering the upper horizontal section (152) out-of-reach for a human inspector standing on the ground. For example, a CML A (151a) on the upper horizontal section (152) is an out-of-reach CML. In contrast, a CML B (151b) on the lower horizontal section (153) is classified as a “within-reach” CML for the human inspector standing on the ground.

Turning to FIG. 1C, FIG. 1C shows a schematic diagram in accordance with one or more embodiments. In one or more embodiments, one or more of the modules and/or elements shown in FIG. 1C may be omitted, repeated, and/or substituted. Accordingly, embodiments of the invention should not be considered limited to the specific arrangements of modules and/or elements shown in FIG. 1C.

As shown in FIG. 1C, FIG. 1C illustrates a telescopic stick (190) for online ultrasonic testing that enables an inspector to easily reach elevated locations for inspection purposes. The isometric view (150a), side view (150b), and front view (150c) collectively show a lightweight telescopic stick (190) having telescopic segments (320a) and swivel segments (320b, 320c). The lightweight telescopic stick (190) is equipped with two swivel joints (191a, 191b), a mounting head (192), and a battery (195). For example, the length of the telescopic segments (320a) may be extended up to 9 meters to access out-of-reach CMLs to facilitate a user performing OSI of equipment and piping network from the ground. The mounting head (192) has an electromagnetic leg (196) and a UT sensor probe (193) attached to a spring (197) for increased shock absorption resistance on the surface of an equipment structure under test (e.g., a pipe wall having ferro-magnetic surface material).

The UT sensor probe (193), or simply referred to as the UT probe, is a device that converts electric energy into an ultrasonic vibration to be applied to a test surface and measures ultrasonic reflections from the test surface. For example, the UT probe (193) may be a piezoelectric and/or magnetostrictive device. The UT probe (193) is spring mounted on the mounting head (192) because the UT probe (193) needs to be in tight contact with the surface under test to have accurate readings. The tight contact is achieved by way of the electromagnetic leg (196) and the spring (197). For example, the surface under test may be the outer surface of a pipe wall (151c) made of ferro-magnetic material, such as iron or steel.

The electromagnetic leg (196) is an electromagnet permanently attached to the mounting head (192). To perform testing on a ferro-magnetic surface, the electromagnetic leg (196) is selectively powered by the battery (195) to press the UT probe (193) against the spring (197) and onto the ferro-magnetic surface of an equipment structure under test (e.g., the pipe wall (151c)). Upon completion of the test, the battery power to the electromagnetic leg (196) is disconnected to disengage the UT probe (193) from the surface of the equipment structure under test. The battery power to the electromagnetic leg (196) may be connected and/or disconnected by a user activated button/switch on the battery (195) or a UT device (198). The side view (150b) illustrates the spring (197) in a relaxed state when the UT probe (193) is disengaged from the pipe wall (151c) and in a compressed state when the UT probe (193) is engaged against the pipe wall (151c).

During operation of the telescopic stick (190), the UT probe (193) is connected to the UT device (198) at the ground level via a long cable (194). The UT device (198) is a device that sends electrical power (e.g., oscillating energy) to the UT probe (193) which converts the electrical power into emitted ultrasonic wave to the equipment structure under test. The UT probe (193) measures the time of flight (i.e., delay time) of the reflected ultrasonic wave to calculate the traveling distance for determining the structure wall thickness. The UT device (198) may be a portable device carried by the user (i.e., the human inspector).

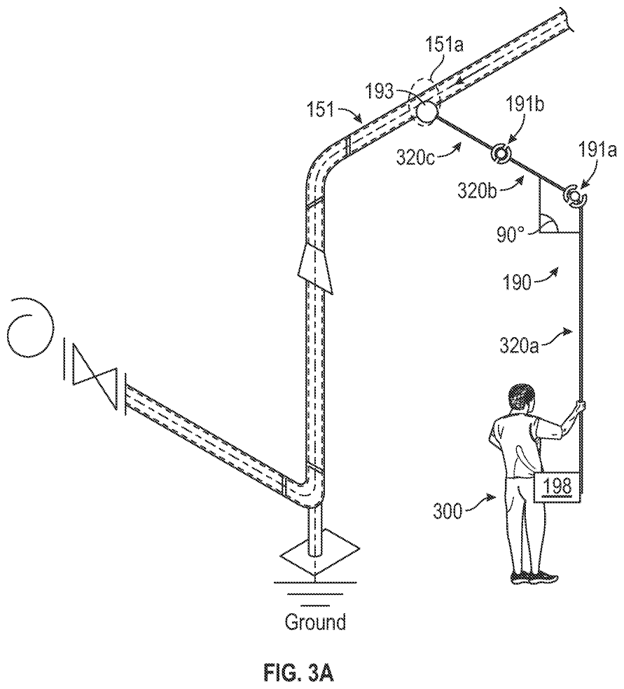

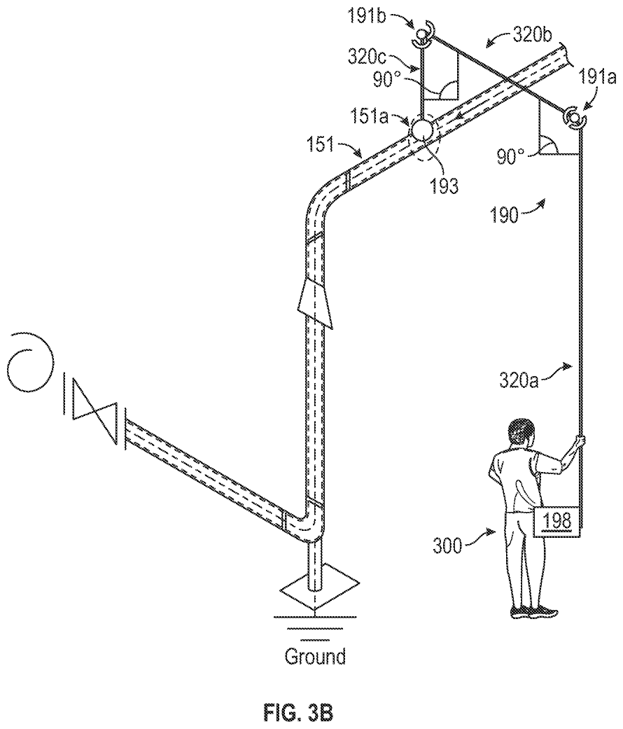

As will be shown in more details in reference to FIGS. 3A-3B below, the swivel joint (191a) allows the telescopic stick (190) to be configured in an L-shaped form to engage the UT probe (193) on two sides of an elevated pipe. In addition, the swivel joint (191b) allows the telescopic stick (190) to be configured in a U-shaped form to engage the UT probe (193) on the top side of the elevated pipe. Accordingly, the telescopic stick (190) allows the test to meet all OSI requirements (i.e., taking measurements every 90° angle covering the entire circumference of the pipe under test).

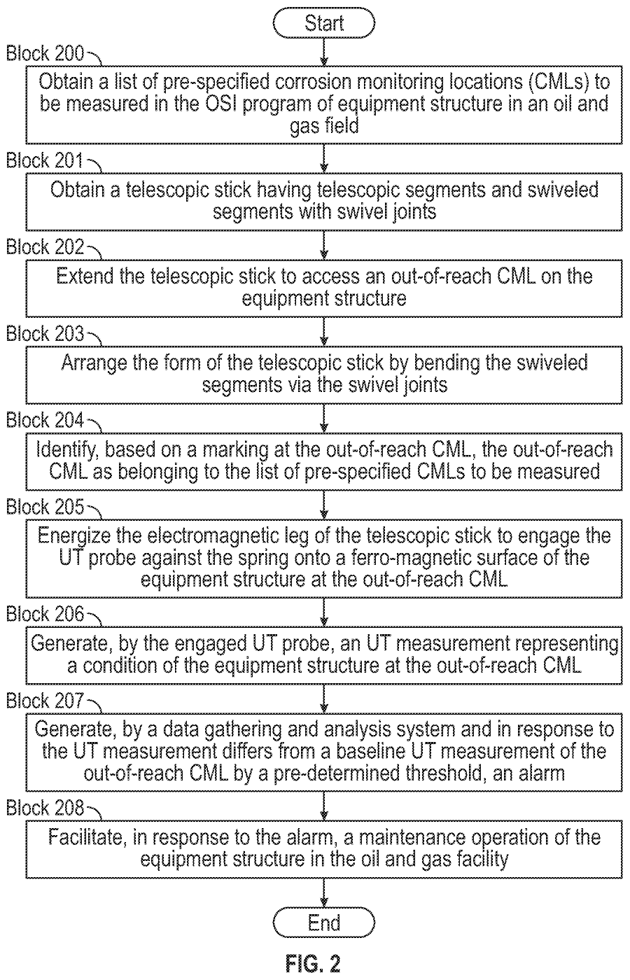

Turning to FIG. 2, FIG. 2 shows a flowchart in accordance with one or more embodiments. Specifically, FIG. 2 describes a method for on-stream inspection (OSI) of an equipment structure in an oil and gas facility. One or more blocks in FIG. 2 may be performed using one or more components as described in FIGS. 1A-1C. While the various blocks in FIG. 1A are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

Initially in Block 200, a list of pre-specified corrosion monitoring locations (CMLs) to be measured in the OSI program of equipment structure in an oil and gas field is obtained. The list is referred to as the OSI CML list. For example, the list may include thousands of CMLs that are out-of-reach from an inspector on the ground but are in frequent need for taking UT measurements to monitor on-going corrosion behavior. The OSI program of equipment and piping network includes periodic rounds of OSIs performed based on an on-going basis, such as quarterly, annually, every 5 years, etc. In one or more embodiments, each CML in the list is marked on the equipment structure so that the very exact locations are repeatedly measured in each OSI round to maintain a clear record of corrosion progression (e.g., the amount of metal lost each year) for estimating the remaining lifetime of a particular portion (e.g., a pipe segment) of the equipment structure.

In Block 201, during a current round of the OSI program of equipment and piping network, a telescopic stick is obtained for the inspector to access out-of-reach CMLs. In one or more embodiments, the telescopic stick described in reference to FIG. 1C above is obtained for a particular round of the OSI program. In particular, the telescopic stick includes telescopic segments, swivel segments, swivel joints, a mounting head with a spring-loaded UT probe and an electromagnetic leg, a battery, and other associated components. The UT probe is communicatively coupled (e.g., via a wired or wireless link) to a UT device, which may be a portable device carried by the inspector. In one or more embodiments, the UT probe may be integrated with an optical scanner.

In Block 202, the telescopic segments of the telescopic stick are extended to exceed a pre-determined length of human reach to allow the inspector accessing a particular out-of-reach CML on the equipment structure. For example, the inspector manually extends the telescopic stick based on a visual height estimate of the particular out-of-reach CML in front of the inspector. In one or more embodiments, the pre-determined length of human reach is set as 2.5 meters.

In Block 203, the form of the telescopic stick is arranged for performing OSI at the particular out-of-reach CML on the equipment structure. For example, the telescopic stick may be arranged into a L-shaped form by bending, via the swivel joints, one of the swivel segments with respect to the telescopic segments. The L-shaped form allows a UT probe of the telescopic stick to engage a ferro-magnetic surface on a left or right side of the equipment structure at the out-of-reach CML. In another example, the telescopic stick may be arranged into a U-shaped form by bending, via the swivel joints, both swivel segments with respect to the telescopic segments. The U-shaped form allows the UT probe to engage the ferro-magnetic surface on a top side of the equipment structure at the out-of-reach CML.

In Block 204, the particular out-of-reach CML is identified based on a marking as belonging to the list of pre-specified CMLs to be measured in the OSI program. In one or more embodiments, the marking is painted or otherwise tagged on the equipment structure at the particular out-of-reach CML to be visually identified by the inspector. In one or more embodiments, the marking includes a machine-readable identifier (e.g., a barcode or a QR code) that is scanned using an optical scanner integrated with the UT probe. The visual marking information or the scanned identifier is manually or automatically compared to the list of pre-specified CMLs to confirm that the particular out-of-reach CML in front of the inspector is to be measured for the current round of the OSI program.

In Block 205, the electromagnetic leg of the telescopic stick is energized to engage the UT probe against the spring onto a ferro-magnetic surface of the equipment structure at the out-of-reach CML. In one or more embodiments, electromagnetic leg is energized by clicking a button or flipping a switch on the battery of the telescopic stick to supply electrical power to an electromagnetic coil in the electromagnetic leg.

In Block 206, an UT measurement representing a condition of the equipment and piping structure at the out-of-reach CML is generated by the engaged UT probe. In one or more embodiments, the UT measurement corresponds to a thickness of a pipe wall where the equipment structure includes a pipe at the out-of-reach CML. The UT measurement is combined with the visual marking information or the scanned machine-readable identifier to generate an OSI monitoring data record of the out-of-reach CML. The OSI monitoring data records of each CML in the OSI CML list for the current round and all prior rounds of the OSI program are stored in and analyzed by a data-gathering and analysis system of the oil and gas facility to estimate remaining lifetimes of the equipment structure at corresponding CMLs.

In Block 207, an alarm is generated in response to the UT measurement differs from a baseline UT measurement of the out-of-reach CML by a pre-determined threshold. The baseline UT measurement of the out-of-reach CML is retrieved from a collection of baseline UT measurements indexed by respective machine-readable identifiers. In one or more embodiments, the baseline UT measurements in the collection are generated within a pre-determined time period of initial installation or retrofit of the equipment structure in the oil and gas facility. The baseline UT measurements represent original conditions (e.g., original pipe wall thickness) of the equipment structure at the pre-specified CMLs to be measured in the OSI program. Accordingly, the baseline UT measurements are stored in the data-gathering and analysis system to form the baseline collection. In one or more embodiments, the UT measurement and the baseline UT measurement of the out-of-reach CML are compared by the data-gathering and analysis system to generate the alarm. In one or more embodiments, the UT measurement and the baseline UT measurement of the out-of-reach CML are compared by the data-gathering and analysis system to generate the alarm.

In Block 208, a maintenance operation of the equipment structure in the oil and gas facility is performed in response to the alarm. In this context, the data-gathering and analysis system analyzes the UT measurement to facilitate performing the maintenance operation. For example, the maintenance operation may include replacing or retrofitting a portion of the equipment structure at the out-of-reach CML.

Turning to FIGS. 3A-3B, FIGS. 3A-3B provide an example of performing OSI of equipment and piping network in oil and gas facilities. The example shown in FIGS. 3A-3B may be, for example, employ one or more components depicted in FIGS. 1A-1C above and the method flowchart depicted in FIG. 2 above. In one or more embodiments, one or more of the modules and/or elements shown in FIGS. 3A-3B may be omitted, repeated, and/or substituted. Accordingly, embodiments of the invention should not be considered limited to the specific arrangements of modules and/or elements shown in FIGS. 3A-3B.

FIG. 3A shows an inspector (300) holding the telescopic stick (190) where the swivel joint (191a) is swiveled in a 90-degree angle rendering the telescopic stick (190) in an L-shaped form to engage the UT probe (193) onto the out-of-reach CML A (151a) on a side wall of the upper horizontal section of the equipment structure (151).

FIG. 3B shows the inspector (300) holding the telescopic stick (190) where both swivel joints (191a, 191b) are swiveled in the 90-degree angle rendering the telescopic stick (190) in a U-shaped form to engage the UT probe (193) onto the out-of-reach CML A (151a) on the top side of the upper horizontal section of the equipment structure (151).

In one or more embodiments, the CML A (151a) depicted in FIGS. 3A-3B is marked with a visible label for the inspector (300) to aim the UT probe (193). The visible label may include a machine-readable pattern (e.g., bar code, QR code) that identifies the particular CML. The UT probe (193) may be integrated with an optical scanner to scan the machine-readable pattern that is combined with the UT measurements into a monitoring data record. As the inspector (300) traverses the entire equipment structure of the oil and gas facility to complete a round of OSI program, the monitoring data records of multiple CMLs may be transmitted in real time to the UT device (198) for storage as a time-stamped OSI monitoring data log. At each CML, the monitoring data record may be transmitted in real time from the UT probe (193) to the UT device (198) wirelessly or via the cable (194) depicted in FIG. 1C above. In one or more embodiments, the time-stamped OSI monitoring data logs of ongoing periodic OSI rounds are transmitted to the data-gathering and analysis system (160) depicted in FIG. 1A above for storage and analysis.

While the invention has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A telescopic stick for on-stream inspection (OSI) of an equipment structure in an oil and gas facility, comprising:
a plurality of telescopic segments;
a first swivel segment and a second swivel segment;
a first swivel joint coupling the plurality of telescopic segments to the first swivel segment;
a second swivel joint coupling the first swivel segment to the second swivel segment;
a mounting head attached to the second swivel segment opposite the second swivel joint;
an ultrasonic transducer (UT) probe mounted on the mounting head via a spring; and
an electromagnetic leg protruding from the mounting head and adjacent to the UT probe,
wherein an extended length of the plurality of telescopic segments exceeds a pre-determined length of human reach to allow a user accessing an out-of-reach condition monitoring location (CML) on the equipment structure,
wherein the electromagnetic leg, when energized, engages the UT probe against the spring onto a ferro-magnetic surface of the equipment structure at the out-of-reach CML,
wherein the engaged UT probe generates an UT measurement representing a condition of the equipment structure at the out-of-reach CML,
wherein an alarm is generated in response to the UT measurement differs from a baseline UT measurement of the out-of-reach CML by a pre-determined threshold, and
wherein a maintenance operation of the equipment structure is performed in response to the alarm.

2. The telescopic stick according to claim 1,
wherein the telescopic stick is arranged into a L-shaped form by bending, via the first or second swivel joint, the first or second swivel segment with respect to the plurality of telescopic segments, and
wherein the L-shaped form allows the UT probe to engage the ferro-magnetic surface on a left or right side of the equipment structure at the out-of-reach CML.

3. The telescopic stick according to claim 1,
wherein the telescopic stick is arranged into a U-shaped form by bending, via the first and second swivel joints, the first and second swivel segments with respect to the plurality of telescopic segments, and
wherein the L-shaped form allows the UT probe to engage the ferro-magnetic surface on a top side of the equipment structure at the out-of-reach CML.

4. The telescopic stick according to claim 1,
wherein the UT probe scans a machine-readable identifier at the out-of-reach CML,
wherein the UT measurement is combined with the scanned machine-readable identifier to generate an OSI monitoring data record of the out-of-reach CML, and
wherein the baseline UT measurement of the out-of-reach CML is stored in a collection of baseline UT measurements indexed by respective machine-readable identifiers.

5. The telescopic stick according to claim 4, wherein the baseline UT measurement is generated within a pre-determined time period of initial installation of the equipment structure in the oil and gas facility.

6. The telescopic stick according to claim 4, wherein the baseline UT measurement is generated within a pre-determined time period of retrofitting the equipment structure at the out-of-reach CML in the oil and gas facility.

7. The telescopic stick according to claim 1, wherein the maintenance operation comprises replacing or retrofitting a portion of the equipment structure at the out-of-reach CML in the oil and gas facility.

8. A system for on-stream inspection of an equipment structure in an oil and gas facility, comprising:
a telescopic stick comprising:
a plurality of telescopic segments;
a first swivel segment and a second swivel segment;
a first swivel joint coupling the plurality of telescopic segments to the first swivel segment;
a second swivel joint coupling the first swivel segment to the second swivel segment;
a mounting head attached to the second swivel segment opposite the second swivel joint;
an ultrasonic transducer (UT) probe mounted on the mounting head via a spring; and
an electromagnetic leg protruding from the mounting head and adjacent to the UT probe,
wherein an extended length of the plurality of telescopic segments exceeds a pre-determined length of human reach to allow a user accessing an out-of-reach condition monitoring location (CML) on the equipment structure,
wherein the electromagnetic leg, when energized, engages the UT probe against the spring onto a ferro-magnetic surface of the equipment structure at the out-of-reach CML,
wherein the engaged UT probe generates an UT measurement representing a condition of the equipment structure at the out-of-reach CML, and
a data-gathering and analysis system configured to:
obtain the UT measurement from the UT probe;
store the UT measurement in a collection of UT measurements of a periodic OSI program;
generate, in response to the UT measurement differs from a baseline UT measurement of the out-of-reach CML by a pre-determined threshold, an alarm; and
facilitate, in response to the alarm, a maintenance operation of the equipment structure in the oil and gas facility.

9. The system according to claim 8,
wherein the telescopic stick is arranged into a L-shaped form by bending, via the first or second swivel joint, the first or second swivel segment with respect to the plurality of telescopic segments, and
wherein the L-shaped form allows the UT probe to engage the ferro-magnetic surface on a left or right side of the equipment structure at the out-of-reach CML.

10. The system according to claim 8,
wherein the telescopic stick is arranged into a U-shaped form by bending, via the first and second swivel joints, the first and second swivel segments with respect to the plurality of telescopic segments, and
wherein the L-shaped form allows the UT probe to engage the ferro-magnetic surface on a top side of the equipment structure at the out-of-reach CML.

11. The system according to claim 8,
wherein the UT probe scans a machine-readable identifier at the out-of-reach CML,
wherein the UT measurement is combined with the scanned machine-readable identifier to generate an OSI monitoring data record of the out-of-reach CML for sending to the data-gathering and analysis system, and
wherein the data-gathering and analysis system further stores a baseline UT measurement of the out-of-reach CML in a collection of baseline UT measurements indexed by respective machine-readable identifiers.

12. The system according to claim 11, wherein the baseline UT measurement is generated within a pre-determined time period of initial installation of the equipment structure in the oil and gas facility.

13. The system according to claim 11, wherein the baseline UT measurement is generated within a pre-determined time period of retrofitting the equipment structure at the out-of-reach CML in the oil and gas facility.

14. The system according to claim 8, wherein the maintenance operation comprises replacing or retrofitting a portion of the equipment structure at the out-of-reach CML in the oil and gas facility.

15. A method for on-stream inspection (OSI) of an equipment structure in an oil and gas facility, comprising:
obtaining a telescopic stick comprising:
a plurality of telescopic segments;
a first swivel segment and a second swivel segment;
a first swivel joint coupling the plurality of telescopic segments to the first swivel segment;
a second swivel joint coupling the first swivel segment to the second swivel segment;
a mounting head attached to the second swivel segment opposite the second swivel joint;
an ultrasonic transducer (UT) probe mounted on the mounting head via a spring; and
an electromagnetic leg protruding from the mounting head and adjacent to the UT probe;
extending the plurality of telescopic segments to exceed a pre-determined length of human reach to allow a user accessing an out-of-reach condition monitoring location (CML) on the equipment structure;
energizing the electromagnetic leg to engage the UT probe against the spring onto a ferro-magnetic surface of the equipment structure at the out-of-reach CML;
generating, by the engaged UT probe, an UT measurement representing a condition of the equipment structure at the out-of-reach CML;
generating, in response to the UT measurement differs from a baseline UT measurement of the out-of-reach CML by a pre-determined threshold, an alarm; and
facilitating, in response to the alarm, a maintenance operation of the equipment structure in the oil and gas facility.

16. The method according to claim 15, further comprising:
arranging the telescopic stick into a L-shaped form by bending, via the first or second swivel joint, the first or second swivel segment with respect to the plurality of telescopic segments,
wherein the L-shaped form allows the UT probe to engage the ferro-magnetic surface on a left or right side of the equipment structure at the out-of-reach CML.

17. The method according to claim 15, further comprising:
arranging the telescopic stick into a U-shaped form by bending, via the first and second swivel joints, the first and second swivel segments with respect to the plurality of telescopic segments,
wherein the U-shaped form allows the UT probe to engage the ferro-magnetic surface on a top side of the equipment structure at the out-of-reach CML.

18. The method according to claim 15, further comprising:
scanning, using the UT probe, a machine-readable identifier at the out-of-reach CML;
combining the UT measurement with the scanned machine-readable identifier to generate an OSI monitoring data record of the out-of-reach CML; and
storing, by a data-gathering and analysis system, the baseline UT measurement of the out-of-reach CML in a collection of baseline UT measurements indexed by respective machine-readable identifiers.

19. The method according to claim 18, wherein the baseline UT measurement is generated within a pre-determined time period of initial installation or retrofit of the equipment structure in the oil and gas facility.

20. The method according to claim 15, wherein the maintenance operation comprises replacing or retrofitting a portion of the equipment structure at the out-of-reach CML in the oil and gas facility.
